(19) United States
(12) Patent Application Publication
(10) Pub. No.: US 2025/0204328 A1
(43) Pub. Date: Jun. 26, 2025

(54) AGRICULTURAL MACHINE FOR WORKING AROUND TRUNKS OF VEGETABLE PLANTS, IN PARTICULAR A SUCKERS REMOVING MACHINE

(71) Applicant: B.M.V. S.R.L., Alba (CN) (IT)

(72) Inventor: Stefano BORIO, Alba (CN) (IT)

(21) Appl. No.: 18/851,631

(22) PCT Filed: Mar. 13, 2023
(86) PCT No.: PCT/IB2023/052387

§ 371 Date: Sep. 26, 2024

(30) Foreign Application Priority Data
Mar. 29, 2022 (IT) 102022000006107

(51) Int. Cl. A01G 3/00

(52) U.S. Cl. CPC A01G 3/00; A01G 2003/005

(57) ABSTRACT

An agricultural machine working around trunks of plants includes a support structure, connectable to a vehicle or tractor, an arm connected to the support structure, providing movement relative to the support structure. An actuator system controls arm movements to selectively move a distal end of the arm towards or away from a trunk of a plant. An agricultural equipment is adapted to work around trunks of plants, connected to the arm's distal end. A safety system prevents the agricultural equipment from damaging trunks of plants. The safety system includes an idle wheel and a sensor. The sensor detects abutment of the idle wheel against the trunk. A control system controls the actuator system so the arm moves if the sensor detects the abutment of the idle wheel against the trunk, thus moving the distal end away from the trunk, preventing the idle wheel from exerting force against the trunk.

The present invention relates to an agricultural machine capable of working around trunks of vegetable plants without damaging them. In particular, the present invention relates to a suckers removing machine adapted to remove suckers from the base of a vegetable plant, e.g. trees and/or grapevine.

Cutting devices are known in the art which comprise an idle rotary disk performing a safety and protection function, mounted to a face of one or more cutting devices and having a radius which is longer than that of the cutting devices. Such disk is adapted to define an abutment which is useful to prevent any undesired objects, e.g. stones or plant trunks or any other objects that should not come in proximity to the cutting devices, from getting close to the cutting devices.

Machines are also known which comprise cutting devices and a frame to which a suitably movable arm is connected. At the end of said arm there is a protection structure mounted idle to the shaft to which the cutting devices are rotatably connected. Such a protection structure comprises a plurality of protrusions adapted to extend the maximum diameter of a support structure beyond the maximum diameter of the cutting devices. Such protrusions are suitably spaced apart to generate cavities having a smaller diameter than the maximum diameter defined by said protrusions and the diameter of the cutting devices. Said protrusions are adapted to come in contact with the trunk of the plant, thus preventing, in many cases, the cutting devices from getting in contact with the trunk of the plant, while the cavities allow the suckers to get in touch with the cutting devices, so that they can be removed.

Machines are known which comprise cutting devices including a feeler device adapted to abut against an object, e.g. the trunk of a vegetable plant. The compression exerted by an object on said feeler device causes the abutting object to be temporarily moved away; however, the device will then quickly come in contact with the same object again, thereby stressing the latter. In fact, such solutions include returning systems adapted to return said cutting elements into the position assumed prior to the abutment, continuing to apply thrust forces against the object.

Grass mowing machines and/or suckers removing machines are known which comprise a main arm, at the distal end of which there is at least one cutting element mounted to an arm. At the distal end of said main arm there is a wheel adapted to rotate idle. Such wheel makes it easier to get over an object, since it causes said main arm to rotate. In particular, the force acting upon said wheel permits overcoming the return force of the main arm, thus allowing it to rotate.

In the solutions currently known in the art, the safety devices, including disks, protection cages, feeler devices and idle wheels, are intended to continue exerting thrust forces on objects to be overcome while an agricultural equipment is operating around such objects.

It is also known to cover those parts which may get in contact with objects with elastically deformable materials, in an attempt to limit any damage that could be done to such objects.

It is known in the agricultural field that the trunks of some vegetable plants, like hazelnut trees, have a particularly thin and delicate bark, e.g. in some periods of the year, so that they may suffer excoriations when forces are applied thereto, e.g. compression forces, even of low intensity.

It has also been observed that the trunks of some vegetable plants, like hazelnut trees, have a particularly thin and delicate bark in some periods of the year, and may undergo severe excoriations especially when scraping forces are applied thereto, e.g. along a vertical axis.

None of the currently known solutions tackles the problem of preventing the safety devices, including idle wheels, from damaging obstacles and/or trunks; in particular, none of the currently known solutions can prevent said safety devices from continuing to exert thrust forces on the trunk of the vegetable plant following a first contact between said safety devices and the trunk.

The present invention aims at solving the problems suffered by the prior art by proposing an innovative solution applicable to several types of vegetable plants around the trunks of which a machine needs to operate.

In particular, the solution according to the present invention makes it possible to prevent the vegetable plants from suffering excoriations while working around the trunks of said vegetable plants.

Even more specifically, the present invention can, when embodied as a suckers removing machine, eliminate most suckers while reducing the risk of the vegetable plant suffering excoriations, in any operating configuration of the machine.

One aspect of the present invention relates to an agricultural machine having the features set out in the appended claim 1.

The features and advantages of the agricultural machine will become apparent from the following description of several possible embodiments thereof, provided herein by way of non-limiting example, as well as from the annexed drawings, wherein:

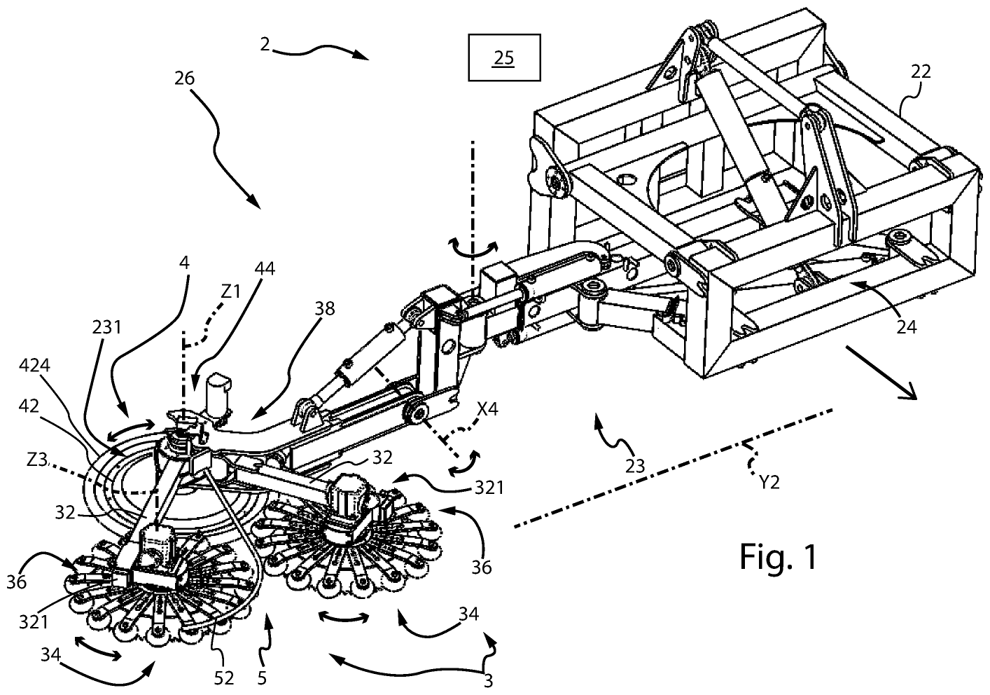

FIG. 1 shows an axonometric view of one possible embodiment of an agricultural machine for working around trunks of vegetable plants, being in particular a suckers removing machine;

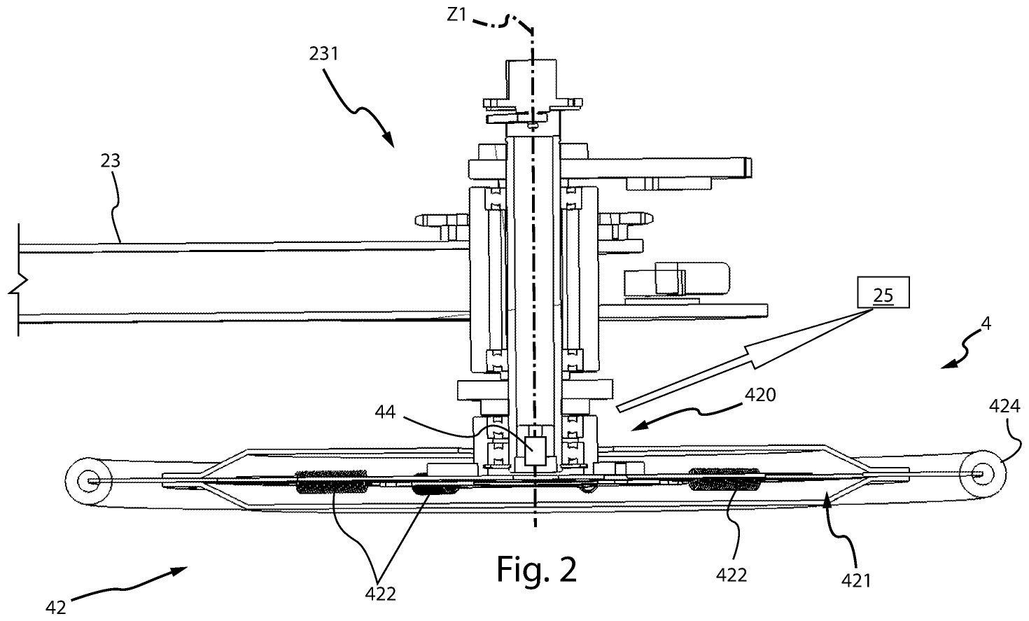

FIG. 2 shows one possible embodiment of a safety system of an agricultural machine according to the present invention, in particular comprising an idle wheel and a sensor;

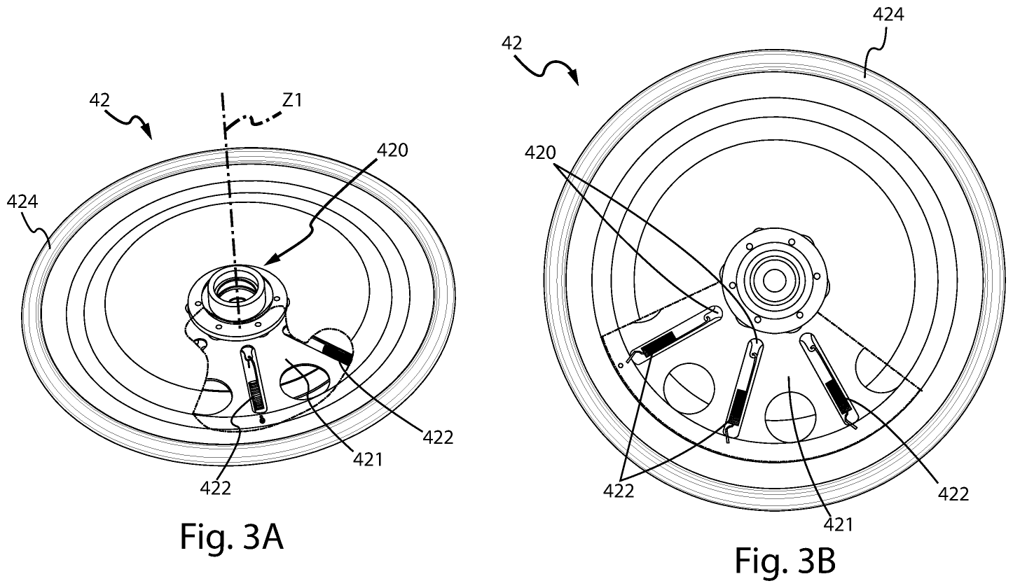

FIGS. 3A and 3B are different views of one possible embodiment of an idle wheel of a safety system according to the present invention; in particular, FIG. 3A is a perspective view of the idle wheel, showing a sectioned portion thereof; FIG. 3B is a plan view of the same idle wheel of FIG. 3A, showing another sectioned portion thereof;

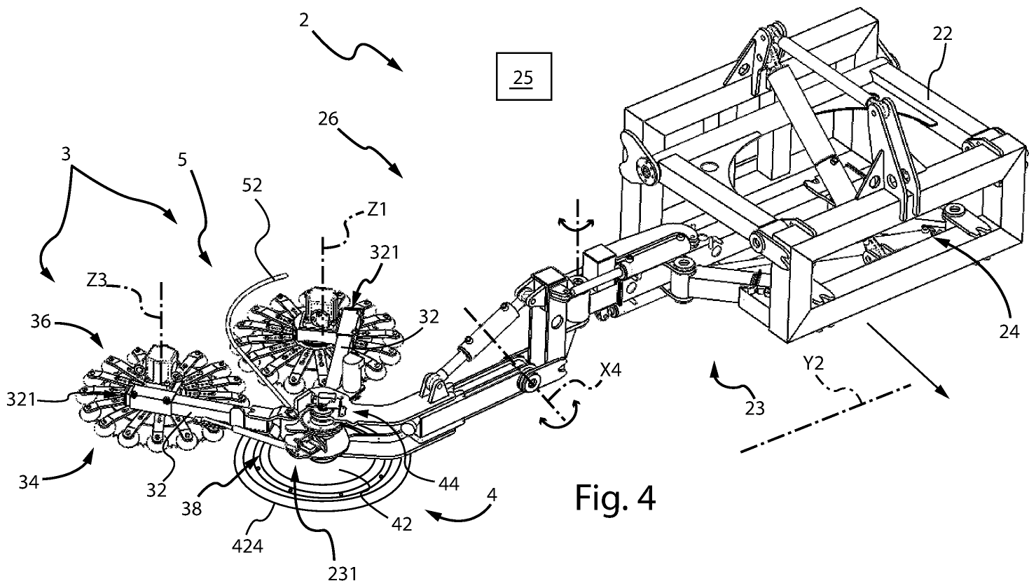

FIG. 4 shows an agricultural machine which is similar to the agricultural machine of FIG. 1, with the two suckers devices in a different configuration than shown in FIG. 1;

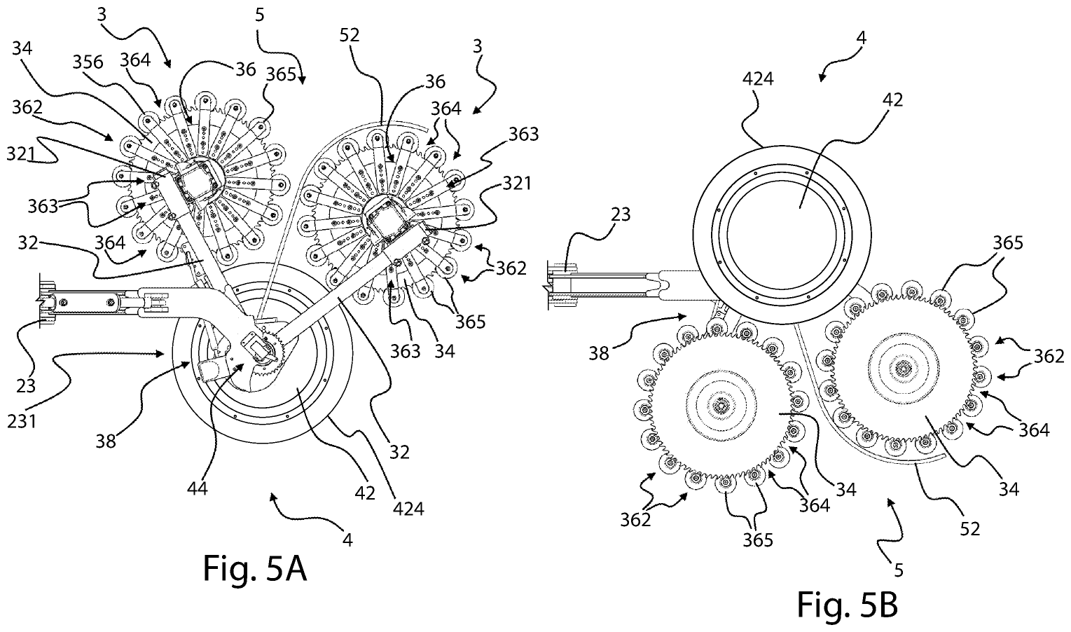

FIGS. 5A and 5B show different views of a detail of a suckers removing machine, e.g. the one shown in FIGS. 1 and 4; in particular, FIG. 5A is a view from above of such portion of the suckers removing machine; FIG. 5B is a view from below of such portion of the suckers removing machine.

With reference to the above-mentioned figures, reference numeral 2 designates as a whole an agricultural machine in different embodiments thereof.

Agricultural machine 2 according to the present invention is particularly suitable for working around trunks of vegetable plants.

Agricultural machine 2 according to the present invention comprises a support structure 22 adapted to be connected to a vehicle or tractor. Advantageously, said agricultural machine 2 is adapted to move along a direction parallel to the plane whereon said agricultural machine 2 operates.

Agricultural machine 2 according to the present invention comprises a main arm 23, connected to said support structure 22. Said main arm 23 is adapted to make a movement relative to said support structure 22, which may be a translational movement, e.g. relative to a horizontal axis; a rotational movement, e.g. about a vertical axis; or a rototraslational movement.

Agricultural machine 2 according to the present invention further comprises an actuator system 24 at least adapted to control the movements, e.g. translation, rotation and/or rototranslation, of said main arm 23 relative to said support structure 22, e.g. relative to a horizontal axis and/or a vertical axis, to selectively move a distal end 231 of main arm 23 towards or away from a trunk of a vegetable plant.

Agricultural machine 2 according to the present invention further comprises at least one agricultural equipment 3. In general, said agricultural equipment 3 is adapted to work around trunks of vegetable plants.

Said agricultural equipment 3 is advantageously connected to said distal end 231 of said main arm 23.

Agricultural machine 2 according to the present invention further comprises a control system 25 adapted to at least control said actuator system 24.

Agricultural machine 2 according to the present invention comprises a safety system 4. Safety system 4 is adapted to prevent said agricultural machine 3 from damaging the trunk of the vegetable plant around which said agricultural equipment 3 is operating.

Said safety system 4 according to the present invention comprises at least one idle wheel 42 and at least one sensor 44.

Said at least one sensor 44 is adapted to detect the abutment of said at least one idle wheel 42 against the trunk of a vegetable plant.

Said control system 25 is adapted to control said actuator system 24 in such a way that said main arm 23 will move, e.g. at least partly by translating, preferably relative to a horizontal axis, and/or by rotating, preferably about a vertical axis, e.g. by rototranslating, in the event that said at least one sensor 44 detects the abutment of said at least one idle wheel 42 against said trunk of a vegetable plant, thereby moving distal end 231 of said main arm 23 away from the trunk of the vegetable plant, so as to prevent said at least one idle wheel 42 from exerting a force against said trunk.

Preferably, said control system 25 is adapted to control said actuator system 24 in such a way as to prevent said at least one idle wheel 42 from abutting against said trunk. In particular, said control system 25 is adapted to control said actuator system 24 in such a way as to prevent said at least one idle wheel 42 from abutting against said trunk after a first abutment has occurred.

According to the present invention, actuator system 24 can appropriately control the position of main arm 23, and particularly distal end 231 thereof, with respect to the trunk of the vegetable plant, so as to allow agricultural equipment 3 to operate correctly while at the same time preventing said idle wheel 42 from causing damage to the vegetable plant due to exertion of a force on said vegetable plant, particularly after a first contact or abutment therewith, thus causing no excoriations to the bark of the trunk. Preferably, the present invention prevents the idle wheel from hitting the trunk of the vegetable plant again after a first contact or abutment therewith has occurred, thus saving the bark of the trunk from excoriations.

Preferably, said control system 25 is adapted to control said actuator system 24 in such a way that said idle wheel 42 will no longer abut against a trunk of a vegetable plant following a detection, by said at least one sensor 44, of a first abutment of said idle wheel 42 against said trunk of a vegetable plant. Even more preferably, said safety system 4 is so designed that said idle wheel 42 will no longer abut against a trunk with which it has already come in abutment once, by keeping said main arm 23 in a rearward position until said agricultural machine 2 has moved past said trunk of the vegetable plant.

Describing now more in detail the construction of an agricultural machine 2 according to the present invention, said support structure 22 defines a load-bearing frame. Said actuator system 24 is, at least partly, constrained to said support structure 22. Said support structure 22 comprises fastening means adapted to allow connecting said support structure 22, and hence the entire agricultural machine 2, to a vehicle or tractor.

Said main arm 23 preferably has a shape that extends substantially along a longitudinal axis, which is preferably perpendicular to a vertical axis. Said main arm 23 may have a wholly rectilinear shape or may include a curved portion, e.g. in proximity to said distal end 231, according to specific requirements.

Said main arm 23 is adapted to move relative to said support structure 22 by making: a translation, e.g. relative to a horizontal axis; a rotation, e.g. about a vertical axis; or a rototranslation, i.e. by moving on a substantially horizontal plane.

It is understood that the vertical and horizontal references used in the present description refer to an ideal working condition of agricultural machine 2; furthermore, when the machine is operating in an inclined condition, different from said ideal condition, such references will have to take into account such inclined condition of agricultural machine 2.

The connection of said main arm 23 to said support structure 22 will depend on the type of movement that said main arm 23 can be caused to make relative to said support structure 22 by said actuator system 24. For example, said main arm 23 is: hinged at one point for rotation; connected through an articulated parallelogram for rototranslation; and/or connected through a slide-guide system for translation.

Preferably, said idle wheel 42 is adapted to rotate freely about a first axis “Z1” in both directions of rotation.

For the purposes of the present description, working around trunks of vegetable plants refers to any agricultural processing carried out in proximity to the trunk of a vegetable plant, useful for the cultivation of the vegetable plant, such as, for example, grass mowing, suckers removal, shredding, tilling, digging, hoeing, etc. Therefore, such agricultural equipment 3 is adapted to execute one or more of the above-mentioned processing steps.

Preferably, said agricultural machine 2 is adapted to work parallel to the soil in which said vegetable plants have been planted. Even more preferably, said agricultural machine 2, and particularly agricultural equipment 3, is adapted to work either in contact with the soil or at a height of just a few centimetres from the soil, e.g. not exceeding 10 cm.

More generally, said control system 25 is advantageously adapted to co-operate with said safety system 4 in order to allow said agricultural equipment 3 to appropriately carry out the processing around the trunk, while preventing said agricultural equipment 3 from causing any damage to the vegetable plant, and while also preventing safety system 4 itself from damaging the vegetable plant, e.g. the bark thereof.

In a preferred, but merely illustrative and non-limiting, embodiment of agricultural machine 2 according to the present invention, said actuator system 24 is a hydraulic system. Preferably, said actuator system 24 comprises one or more pistons adapted to move at least said main arm 23 relative to said support structure 22, as previously described herein. Preferably, said actuator system 24 is adapted to cause said main arm 23 to make a rototranslation, wherein the rectilinear component is parallel to a second axis “Y2”, with reference to a working configuration of agricultural machine 2.

Preferably, said hydraulic actuator system 24, controlled by control system 25, prevents safety system 4, and particularly said idle wheel 42, from exerting any thrust forces on the trunk of the vegetable plant following a first abutment of idle wheel 42 against the trunk of the vegetable plant.

More generally, said agricultural machine 2 according to the present invention further comprises an adjustment system 26. Said adjustment system 26 is adapted to adjust the position of said agricultural equipment 3 in space. For example, said adjustment system 26 may allow changing the angle of said main arm 23, or at least part thereof, relative to at least a fourth axis “X4”, e.g. a horizontal axis, which is, for example, perpendicular to said first axis “Z1” and to said second axis “Y2”. Preferably, the angle of said main arm 23 can be adjusted with respect to two axes.

In addition, said adjustment system 26 may allow changing the longitudinal extension of said main arm 23, e.g. by extending or retracting it, as required by the circumstances.

In addition, said adjustment system 26 may allow changing the inclination of at least a portion of said support structure 22, e.g. in order to set said agricultural machine 2 into inclined configurations, which may be useful, for example, when working on hilly areas.

Advantageously, said control system 25 is adapted to control said adjustment system 26.

The embodiment of agricultural machine 2 that includes said adjustment system 26 makes it possible to suitably control the position of said agricultural equipment 3, preferably taking also into account the information obtained by means of said safety system 4, so as to avoid damaging the vegetable plant.

Preferably, said control system 25 is adapted to control, at least partly, said agricultural equipment 3, e.g. for activating and deactivating it.

Describing now more in detail safety system 4 according to the present invention, in one possible, but merely illustrative and non-limiting, embodiment of agricultural machine 2 according to the present invention said idle wheel 42 comprises return elements 422. Said return elements 422 are adapted to allow said idle wheel 42 to change the position of the axis of symmetry, or of the axis of rotation, in case of abutment against said trunk of the vegetable plant and to return into an idle position following the action exerted on said idle wheel 42 by said trunk of the plant, particularly with the axis of symmetry or rotation of idle wheel 42 returning into the idle or initial position.

The present embodiment permits translating said idle wheel 42, thus damping the impact force exerted by said idle wheel 42 on the trunk of the vegetable plant.

Preferably, in case of abutment against a trunk of a vegetable plant, said movable portion 421 will translate, thereby changing the axis of symmetry of idle wheel 42, which will become parallel to said first axis “Z1”. In the idle or initial position, the axis of symmetry of idle wheel 42 coincides with said first axis “Z1”.

Preferably, said return elements 422 are evenly distributed radially, so that they can cause said idle wheel 42, or at least part thereof, to translate regardless of the portion of said idle wheel 42 which is abutting against a trunk of a vegetable plant.

Preferably, said return elements 422 are a plurality of coil springs.

In one possible, but merely illustrative and non-limiting, embodiment of agricultural machine 2 according to the present invention, said at least one sensor 44 is adapted to determine the position of the axis of symmetry or of the axis of rotation of said idle wheel 42 relative to said idle position. In particular, through said sensor 44 it is possible to detect the variation occurring in the axis of symmetry or in the axis of rotation of said idle wheel 42.

The present embodiment permits determining the abutment of said idle wheel 42 against the trunk of a vegetable plant because the axis of symmetry or the axis of rotation of said idle wheel 42 changes relative to an idle position. In the present embodiment, said sensor 44 is an optical sensor or a proximity sensor.

In an alternative embodiment, said idle wheel 42 is a solid or monolithic wheel.

In one possible, but merely illustrative and non-limiting, embodiment of agricultural machine 2 according to the present invention, said at least one sensor 44 is adapted to determine the force being applied to the hub of said idle wheel 42 or to the axle about which said idle wheel 42 can turn. In particular, through said sensor 44 it is possible to detect the application of a force to said idle wheel 42, particularly to the hub or the axle of idle wheel 42.

The present embodiment permits determining the abutment of said idle wheel 42 against the trunk of a vegetable plant because a force is exerted transversally on the axle or the hub of idle wheel 42. In the present embodiment, said sensor 44 is a force sensor, e.g. a load cell, an electronic sensor, a capacitive sensor, a pneumatic sensor, etc. Preferably, said sensor 44 is comprised in the hub or in the axle of idle wheel 42.

In one possible, but merely illustrative and non-limiting, embodiment, said safety system 4 may comprise an additional sensor, electronically connected to control system 25, which is adapted to detect the rotation of said idle wheel 42 relative to its own axis of rotation, e.g. an angular sensor. Preferably, said angular sensor permits reducing the error in the detection made by sensor 44, thereby improving its accuracy, e.g. when sensor 44 detects the application of a force and/or a variation in the axis of symmetry of idle wheel 42, but there is no rotation of such idle wheel 42.

In one possible, but merely illustrative and non-limiting, embodiment, said safety system 4 may comprise a further sensor, electronically connected to control system 25, which is adapted to determine the position of said agricultural equipment 3 in relation to said distal end 231 of main arm 23, e.g. adapted to detect the rotation about an axis, e.g. a vertical axis, such sensor being, for example, an angular sensor. Preferably, upon reaching a predetermined position of said agricultural equipment 3 in relation to said distal end 231 of main arm 23, control system 25 may control said actuator system 24 to move said main arm 23, causing it to return into the position taken by such arm 23 prior to the detection, by said sensor 44, of the abutment of said at least one idle wheel 42 against the trunk of a plant.

In a preferred, but merely illustrative and non-limiting, embodiment of agricultural machine 2 according to the present invention, at least one elastic member 424 is comprised on the outer perimeter of said idle wheel 42. Said elastic member 424 is adapted for damping, at least partly, the impact force of idle wheel 42 against the trunk of the vegetable plant. The present embodiment permits reducing any damage that may be caused by said idle wheel 42 abutting against said trunk of the vegetable plant.

More generally, said elastic member 424 is adapted to deform elastically. The construction details of said elastic member 424 will not be described in detail herein, since they are already known to a person skilled in the art.

In an alternative embodiment of safety system 4, said at least one sensor 44 is located at the periphery of idle wheel 42, consisting, for example, of a plurality of sensors, or one evenly distributed sensor, adapted to detect a deformation of said elastic member 424, the latter being made of a deformable elastic material, wherein such deformation is caused by the abutment of said elastic member 424 of idle wheel 42 against a trunk of a vegetable plant.

In an alternative embodiment of safety system 4, said idle wheel 42 comprises a plurality of rolling elements, evenly distributed along the circumference of idle wheel 42, which in turn are coated with a material adapted to become elastically deformed, for the purpose of damping shocks. In such an embodiment, said at least one sensor 44 is adapted to detect the impact of one or more of said rolling elements against the trunk of a vegetable plant, e.g. by detecting a change in the position of the axis of rotation of one or more of the rolling elements, and/or the force being applied to one or more pins about which such rolling elements can turn.

More generally, said at least one sensor 44 is electrically and electronically connected to control system 25.

More generally, said at least one sensor 44 is adapted to detect the abutment of said idle wheel 42, or at least part thereof, against a trunk of a vegetable plant, and may be implemented using different technologies and typologies, e.g. mechanical, electrical, electronic and/or pneumatic, even differing from those illustrated herein.

In a preferred, but merely illustrative and non-limiting, embodiment of agricultural machine 2 according to the present invention, said idle wheel 42, which is preferably a single idle wheel 42, is pivoted to distal end 231 of main arm 23. Preferably, said idle wheel 42 is adapted to turn freely about said first axis “Z1”, the latter being a substantially vertical axis. The present embodiment permits controlling the position of distal end 231 of main arm 23 relative to the trunk of the vegetable plant around which agricultural equipment 3 is operating.

Describing now the construction details of one possible embodiment of said idle wheel 42, it comprises: a connection portion 420 adapted to be rotatably fixed to the distal end of main arm 23, so that it can turn freely in both directions of rotation, preferably about the first axis “Z1”, e.g. mounted to a pin or a hub.

In one possible embodiment, said idle wheel 42 further comprises a movable portion 421, e.g. having a discoid shape, which is movable relative to said connection portion 420, being in particular designed to change position relative to the plane in which said movable portion 421 lies. Preferably, said movable portion 421 is adapted to translate in a plane whose normal is the axis of rotation of said idle wheel 42, e.g. said first axis “Z1”. In particular, the variation in the position of movable portion 421 relative to connection portion 420 causes a variation of the axis of symmetry of idle wheel 42.

Said return elements 422 are adapted to keep said movable portion 421 in an idle position and also permit a variation in the position of movable portion 421 relative to connection portion 420 in case of abutment of said idle wheel 42 against the trunk of a vegetable plant. Preferably, said return elements 422 are connected, at one end thereof, to said movable portion 421 and, at the opposite end, to said connection portion 420. In the present embodiment, said elastic member 424 is located at the periphery of said movable portion 421.

In the present embodiment, said sensor 44 is located in proximity to said connection portion 420 of idle wheel 42, so that it can detect a movement of said movable portion 421 relative to said connection portion 420. In the present embodiment, said sensor 44 is, for example, a proximity sensor adapted to detect a variation in the position of said movable portion 421 from its idle position. In particular, the variation in the position of said movable portion 421 is such as to change the axis of symmetry of said idle wheel 42.

Preferably, said return elements 422 are coil springs arranged into suitable housings formed in the structure of movable portion 421.

Preferably, said movable portion 421 comprises covering elements or covers. Said covers are adapted to prevent any foreign bodies from entering the structure of idle wheel 42, particularly at said return elements 422.

FIG. 2 shows one possible, but merely illustrative and non-limiting, embodiment of a safety system 4 of an agricultural machine 3 according to the present invention; in particular, this embodiment of safety system 4 comprises a single idle wheel 42 and one sensor 44.

In the illustrated embodiment, said idle wheel 42 is constrained, in particular pivoted, to a distal end 231 of a main arm 23 of an agricultural machine 2. Said idle wheel 42 is adapted to turn freely in both directions of rotation about a first axis “Z1”, e.g. a vertical axis.

Sensor 44 of said safety system 4 is constrained, for example, to distal end 231 of main arm 23, at the first axis “Z1”, for detecting any variations occurring in the axis of symmetry of idle wheel 42. Said sensor 44 is electrically and electronically connected to control system 25 for the purpose of controlling said actuator system of agricultural machine 2 as a function of the abutments detected by said safety system 4.

Said idle wheel 42 is fixed to said distal end 231 of main arm 23 through a connection portion 420. To said connection portion 420 said movable portion 421 is constrained, which can move relative to said connection portion 420, in particular by translating in a plane perpendicular to said first axis “Z1”.

Said movable portion 421 is connected to said connection portion 420 through a plurality of return elements 422, which are evenly distributed radially.

On the outer peripheral portion of movable portion 421 an elastic member 424 is fixed, e.g. ring-shaped, made of elastic material.

Describing now more in detail one possible embodiment of said idle wheel 42 of safety system 4, FIG. 3A shows idle wheel 42 in a perspective view.

In this figure one can see a sectioned portion of idle wheel 42, showing the inside of idle wheel 42, which is normally covered by said covering elements or covers. In the sectioned portion, return elements 422 are visible in the form of coil springs, which are fixed between connection portion 420 and movable portion 421.

Said idle wheel 42 is adapted to rotate about said first axis “Z1”. In an idle position, said movable portion 421 is adapted to cause the axis of symmetry to coincide with said first axis “Z1”. In case of abutment of said idle wheel 42 against a trunk of a vegetable plant, said movable portion 421 will translate, thereby causing the axis of symmetry of idle wheel 42 to change into an axis parallel to said first axis “Z1”.

Around the outer circumference of idle wheel 42 there is a ring-shaped elastic member 424 adapted to abut against a trunk of a vegetable plant and become elastically deformed as a result.

FIG. 3B shows the same idle wheel 42 of FIG. 3A in a plan view, in which another sectioned portion is visible. Three return elements 422, implemented as coil springs, are visible in this figure, which are connected between connection portion 420 and movable portion 421, being housed in suitable housings formed in movable portion 421. This figure clearly shows the even radial distribution of said return elements 422 along the circumference of idle wheel 42.

Said elastic member 424 is fitted around the outer circumference of idle wheel 42.

In a preferred, but merely illustrative and non-limiting, embodiment of agricultural machine 2 according to the present invention, said agricultural machine 2 is a suckers removing machine 2. Said suckers removing machine 2 is adapted to remove suckers from the trunk of a vegetable plant.

Alternatively, said agricultural machine 2 may be a hoeing machine, a shredding machine, a grass mower, etc.

With reference to the embodiment wherein said agricultural machine is a suckers removing machine 2, it is designed, according to the present invention, in such a way that at the distal end 231 of said main arm 23 two agricultural equipments 3 are comprised in the form of two suckers removing devices 3.

Preferably, each suckers removing device 3 comprises: an arm 32; at least one cutting device 34, and at least one protection structure 36.

Each arm 32 is hinged at one end to distal end 231 of main arm 23, being thus rotatable about a first axis “Z1”, e.g. the axis about which idle wheel 42 can turn freely.

Said at least one cutting device 34 is fixed to distal end 321 of arm 32.

Said at least one protection structure 36 is adapted to rotate idle, in particular it is free to rotate in both directions of rotations about a third axis “Z3”, facing said cutting device 34. In the embodiment wherein said cutting devices 34 are blades or one or more disks, said third axis “Z3” about which said protection structure 36 rotates is the same axis about which said cutting device 34 rotates. Preferably, said third axis “Z3” is a substantially vertical axis.

Preferably, each cutting device 34 is driven, e.g. rotated, by means of a dedicated actuator device, e.g. a motor, e.g. an electric or hydraulic motor.

Said at least one protection structure 36, which faces towards said cutting device 34, is preferably located at a predetermined distance from said cutting device 34 with reference to the third axis “Z3”.

Said at least one protection structure 36 comprises a plurality of protrusions 362 suitably spaced apart radially along a perimeter of said protection structure 36, thus defining a plurality of cavities 364 between said protrusions 362.

Preferably, said protrusions 362 extend along at least an axis perpendicular to said third axis “Z3” by a greater quantity than the extension of said at least one cutting device 34 along said perpendicular axis. Each cavity 364 has a bottom whose distance from said third axis “Z3”, along at least an axis perpendicular to said third axis “Z3”, is shorter than the extension of said at least one cutting device 34 along said perpendicular axis, so that the suckers entering said cavity 364 will come in contact with said cutting device 34.

Preferably, each protrusion 362 comprises at least a first portion extending relative to said third axis “Z3” by a quantity at least equal to said predetermined distance. Each protrusion 362 comprises at least one abutment element 365 which can rotate freely in both directions of rotation about an axis different from said third axis “Z3”.

Preferably, said first portion of each protrusion extends relative to said third axis “Z3” by a quantity greater than said predetermined distance. Preferably, said first portion comprises an inclined and/or curved portion.

Preferably, said protrusions 362 are removably secured by said protection structure 36. Even more preferably, each protrusion 362 comprises an adjuster device 363 adapted to adjust the position of each protrusion 362 relative to said protection structure 36. Preferably, said adjuster devices 363 are a plurality of holes that make it possible to fasten said protrusions 362 into different positions with respect to said protrusion structure 36.

Preferably, each protrusion 362 is designed in a manner such that said abutment element 365 is located at the distal end of each protrusion 362.

More generally, said suckers removing machine 2 is advantageously so designed that said two suckers removing devices 3 are adapted to assume a working configuration. In particular, said two suckers removing devices 3 are moved by means of a hydraulic system 38.

Said hydraulic system 38 being adapted to keep said suckers removing devices 3 in the working configuration.

For the purposes of the present description, the term “working configuration” refers to the configuration assumed by agricultural machine 2 prior to approaching a trunk of a vegetable plant to carry out the intended work, i.e. before said agricultural machine 2, and particularly agricultural equipment 3, begins working around said trunk.

In a preferred embodiment of suckers removing machine 2, according to the present invention, said safety system 4 comprises a feeler device 5. Said feeler device 5 comprises an abutment portion 52.

Preferably, said feeler device 5 is adapted to disable said hydraulic system 38 of suckers removing devices 3, letting said arms 32 turn idle as long as a trunk of a vegetable plant is acting upon said abutment portion 52.

More generally, said feeler device 5 of safety system 4, which comprises an abutment portion 52, is adapted to disable a hydraulic system of at least one agricultural equipment 3 of a generic agricultural machine 2, letting said at least one agricultural equipment 3 turn idle, e.g. about said first axis “Z1”, as long as a trunk of a vegetable plant is acting upon said abutment portion 52. For example, said hydraulic system of said at least one agricultural equipment 3 is adapted to control the rotation of agricultural equipment 3 about said first axis “Z1”.

Referring back to the embodiment of suckers removing machine 2, both of said arms 32 rotate about said first axis “Z1”. Said first axis “Z1” is a substantially vertical axis.

The present embodiment allows the two suckers removing devices 3 to work along the entire perimeter of the trunk of the vegetable plant, without exerting any thrust forces on said trunk of the vegetable plant.

In the preferred embodiment, said feeler device 5 comprises a switch, e.g. a microswitch, adapted to detect the displacement of said abutment portion 52. Preferably, said abutment portion 52 has, advantageously, a rod-like elongate structure, suitably shaped to follow, at least partly, the outer profile of a protection structure 36 of a suckers removing device 3, so that the trunk of a vegetable plant will abut against said abutment portion 52 of feeler device 5, thus allowing arms 32 of suckers removing devices 3 to rotate freely, prior to abutting against protection structure 36 of a suckers removing device 3. The present solution prevents suckers removing devices 3 from being subjected to a thrust force capable of pushing them against the trunk of the vegetable plant.

Due to this freedom of movement of suckers removing devices 3, and particularly of arms 32, no thrust forces generated by devices or elements included in suckers removing machine 2 are present in the action of suckers removing devices 3 upon the trunk of the vegetable plant.

For the purposes of the present description, “disabled hydraulic system 38” means that the oil in hydraulic system 38 is not under pressure and therefore cannot flow freely in hydraulic system 38, so that arms 32 are free to move without opposing any resistance to any thrust action exerted upon them.

Preferably, such freedom of rotation of arms 32 persists as long as said feeler device 5, and particularly said abutment portion 52, is abutting against a trunk of a vegetable plant, and/or until said arms 32 reach a released configuration, which corresponds to a predefined angle of rotation relative to the working configuration, e.g. less than 180°, preferably approx. 160°. In particular, when said feeler device 5, and particularly said abutment portion 52, is no longer in abutment, hydraulic system 38 of suckers removing devices 3 will be activated again, thus moving said arms 32 back into the working configuration.

Preferably, upon reaching said released configuration, in particular upon reaching said angle of rotation, detected by a sensor, e.g. a limit switch, a microswitch and/or an angular sensor, preferably comprised in safety system 4 and electronically connected to control system 25, said control system 25 will control said actuator system 24 to cause said main arm 23 to move, in particular forwards, preferably returning into the position assumed by said arm 23 before said sensor 44 detected the abutment of said at least one idle wheel 42 against the trunk of a plant. With the present solution, suckers removing devices 3 can work all around the trunk of the vegetable plant.

Preferably, said released configuration is such that said suckers removing devices 3 are already in a predetermined position relative to the trunk of the plant during the movement of suckers removing machine 2, so that, even when said hydraulic system 38 is activated and returns said suckers removing devices 3 into the working configuration and/or said actuator system 24 moves said main arm 23 forwards, no thrust force will be exerted on the trunk of the vegetable plant.

More generally, when switching from the working configuration to the released configuration, hydraulic system 38 is disabled and lets arms 32 rotate freely about said first axis “Z1”. Conversely, when switching from the released configuration to the working configuration, hydraulic system 38 preferably generates a thrust force sufficient to rotate said arms about said first axis “Z1” in order to speed up the return into the working configuration.

FIG. 1 shows an axonometric view of one possible embodiment of an agricultural machine 2, in particular a suckers removing machine 2, adapted to work around trunks of vegetable plants, in particular for removing suckers.

FIG. 1 shows suckers removing machine 2 in a working configuration. In this figure one can see one possible embodiment of support structure 22 adapted to be attached to a tractor.

The drawing shows, at least partly, actuator system 24 adapted to control the movements of said main arm 23 in order to selectively move distal end 231 of main arm 23 towards or away from a trunk of a vegetable plant. Said main arm 23 is connected, e.g. at the end opposite said distal end 231, to said support structure 22. In the illustrated embodiment, said main arm 23 is connected to support structure 22 through an articulated parallelogram to permit a rototranslation of said arm 23 relative to said support structure 22. Said articulated parallelogram can be moved by means of said actuator system 24, in particular a piston, which is controlled by said control system 25. In particular, said actuator system 24 permits moving main arm 23, with a motion component thereof parallel to said second axis “Y2”.

Distal end 231 of ain arm 23 is connected to two suckers removing devices 3, both adapted to rotate about a first axis “Z1”.

Said main arm 23 is designed in a manner such that, through adjustment system 26, the spatial position of the two suckers removing devices 3 can be adjusted according to specific working requirements, e.g. by tilting, lifting or lowering the terminal portion of main arm 23, e.g. by causing it to rotate about said fourth axis “X4”, which is perpendicular to said first axis “Z1”, or about a vertical axis.

Idle wheel 42 of safety system 4 is constrained to distal end 231 of main arm 23. Said idle wheel 42 is adapted to turn idle about said first axis “Z1”. Located at distal end 231 of main arm 23, in axis with said first axis “Z1”, said sensor 44 of safety system 4 can detect the abutment, and possibly any repeated abutment, of said idle wheel 42 against a trunk of a vegetable plant.

Said idle wheel 42 comprises, on its outer circumference, a ring-shaped elastic member 424 made of elastic material.

Each suckers removing device 3 is designed with a disk-shaped cutting device 34 fixed to the distal end 321 of each arm 32. Above said cutting device 34, facing towards it, there is a protection structure 36 adapted to turn idle about a third axis “Z3”, which is the axis about which said cutting device 34 rotates, driven by an actuator device.

In FIG. 1, the two suckers removing devices 3 are in a working configuration. Said suckers removing devices 3 are moved by means of a hydraulic system 38.

FIG. 1 shows said safety system 4 to include a feeler device 5. Said feeler device 5 comprises an abutment portion 52, shaped as a bent rod, which follows the outer profile of protection structure 36 associated with a cutting device 34. In particular, said abutment portion 52 is located in proximity to that suckers removing device 3 which will first approach the trunk of a vegetable plant.

FIG. 4 shows an agricultural machine 2 that is similar to agricultural machine 2 of FIG. 1, but with the two suckers devices 3 in a different configuration, namely in a released configuration, wherein the two suckers removing devices 3 have turned about a first axis “Z1” by a predefined angle, compared with the configuration shown in FIG. 1.

As aforementioned, in FIG. 4 both suckers removing devices 3 are in a released configuration. In particular, once suckers removing devices 3 have reached such configuration, particularly once they have turned about said first axis “Z1” by a predefined angle, said control system 25 will control said actuator system 24 to cause said main arm 23 to move, in particular forwards, and preferably return into the position that was assumed by said arm 23 before said sensor 44 detected the abutment of said at least one idle wheel 42 against the trunk of a plant.

Preferably, when switching from the released configuration to the working configuration, suckers removing devices 3 are controlled in such a way as to be quickly returned into the working configuration, particularly by means of hydraulic system 38.

FIG. 4 shows said safety system 4 to include a feeler device 5. Said feeler device 5 comprises an abutment portion 52, shaped as a bent rod, which follows the outer profile of protection structure 36 associated with a cutting device 34. In particular, said abutment portion 52 is located in proximity to suckers removing device 3 which will be the last to move away from the trunk of a vegetable plant.

More generally, FIG. 4 shows support structure 22 and, at least partly, actuator system 24 adapted to control the movements of main arm 23 to selectively move distal end 231 of main arm 23 towards or away from a trunk of a vegetable plant, as already specified for the agricultural machine of FIG. 1. In fact, main arm 23 is connected to said support structure 22, e.g. to the end thereof opposite said distal end 231, by means of an articulated parallelogram, movable by means of said actuator system 24, which is controlled by control system 25. The two suckers removing devices 3 are constrained to distal end 231 of main arm 23, being both adapted to rotate about a first axis “Z1”. Main arm 23 is designed in a manner such that, through adjustment system 26, the spatial position of the two suckers removing devices 3 can be adjusted according to specific working requirements, e.g. by rotating it about said fourth axis “X4” and/or about a vertical axis.

Idle wheel 42 of safety system 4 is constrained to distal end 231 of main arm 23. Said idle wheel 42 is adapted to turn idle about said first axis “Z1”. At distal end 231, in axis with said first axis “Z1”, said sensor 44 of safety system 4 is located to detect the abutment, and possibly any repeated abutment, of said idle wheel 42 against a trunk of a vegetable plant.

Said idle wheel 42 comprises, on its outer circumference, a ring-shaped elastic member 424 made of elastic material.

In FIG. 4, each suckers removing device 3 comprises a disk-shaped cutting device 34, above which, facing towards it, there is a protection structure 36 adapted to turn idle about a third axis “Z3”, which is the axis about which said cutting device 34 rotates, driven by an actuator device.

FIG. 5A shows, in a view from above, a detail of suckers removing machine 2 illustrated in FIGS. 1 and 4. From this figure one can better understand the relative arrangement of arms 32, cutting devices 34 and protection structure 36, particularly in the working configuration. Suckers removing devices 3 can be moved by means of the hydraulic system 38.

A plurality of protrusions 362 are fixed to protection structure 36. In between various protrusions 362 said cavities 364 are defined, where the suckers, once they have entered cavity 364, are removed from the vegetable plant by cutting device 34.

FIG. 5A also shows one possible embodiment of protrusions 362. In such an embodiment, each protrusion 362 is fixed to protection structure 36. In this figure one can also see one possible embodiment of adjuster devices 363 for adjusting the position of protrusions 362 with respect to said protection structure 36.

At the distal end of protrusion 362 an abutment element 365 is comprised, which can be removed from protrusion 362, e.g. for replacement. In the present embodiment, said abutment element 365 further increases the extension of protrusions 362 relative to both said third axis “Z3” and the axis perpendicular thereto.

Each suckers removing device 3 shown in the drawing comprises sixteen protrusions 362 equally spaced apart radially. The number of protrusions 362 and the distance between them is merely indicative, since it is possible to change both their number and their distance depending on specific requirements and/or the dimensions of cutting device 34. In the illustrated embodiment, said cutting device 34 is a disk.

FIG. 5A also shows distal end 231 of main arm 23 to which idle wheel 42 of safety system 4 is connected, just like arms 32 of suckers removing devices 3. Said idle wheel 42 comprises, on its outer circumference, an elastic member 424.

The position of idle wheel 42, and particularly the axis of symmetry and/or the axis of rotation thereof, is detected by sensor 44, which is also fixed to distal end 231 of main arm 23.

In FIG. 5A one can also see feeler device 5 of safety system 4. Feeler device 5 comprises an abutment portion 52 for disabling said hydraulic system 38 of suckers removing devices 3, letting arms 32 turn freely as long as the trunk of a vegetable plant is acting upon said abutment portion 52. Said abutment portion 52 is shaped as a bent rod that follows the outer profile of protection structure 36 associated with a cutting device 34.

FIG. 5B shows, in a view from below, a detail of suckers removing machine 2 illustrated in FIGS. 1 and 4. From this figure one can understand how a pair of suckers removing devices 3 and idle wheel 42 of safety system 4 are connected to main arm 23. This figure allows a better understanding of one possible embodiment of cutting devices 34 and of protection structure 36, particularly of protrusions 362. Suckers removing devices 3 can be moved by means of hydraulic system 38.

FIG. 5B shows a cutting device 34 in the form of a disk included in each suckers removing device 3. A plurality of protrusions 362 of protection structure 36 are also visible. In between the various protrusions 362 said cavities 364 are defined, in which the suckers, once they have entered cavity 364, are removed from the vegetable plant by cutting device 34. To the distal end of each protrusion 362 an abutment element 365, in the form of a wheel comprising elastic material, is fixed and can turn freely.

FIG. 5B shows said safety system 4 to include a feeler device 5. Said feeler device 5 comprises an abutment portion 52, shaped as a bent rod, which follows the outer profile of protection structure 36 associated with a cutting device 34. In particular, said abutment portion 52 is located in proximity to that suckers removing device 3 which will first approach the trunk of a vegetable plant.

More generally, agricultural machine 2 according to the present invention permits moving said main arm 23, in particular backwards, whenever said idle wheel 42 abuts against a trunk of a vegetable plant, in particular in such a way that no thrust force will be exerted on the vegetable plant by said idle wheel 42. Said sensor 44 is adapted to detect the abutment of said idle wheel 42 against the trunk of a vegetable plant, e.g. by sensing a change in the axis of symmetry and/or rotation of said idle wheel 42 and/or the presence of a force being exerted on the pin or hub of idle wheel 42, so that control system 25 can control actuator system 24 to move said main arm 23.

Preferably, agricultural machine 2 according to the present invention is designed in a manner such that, if said idle wheel 42 abuts against the trunk of a vegetable plant, control system 25 will control actuator system 24 to move main arm 23 away, so that idle wheel 42 will no longer be in contact with the trunk of a vegetable plant, e.g. when two suckers removing devices 3 are positioned around the trunk of the vegetable plant.

Preferably, suckers removing machine 2 according to the present invention makes it possible to let agricultural equipment 3, e.g. arms 32 of suckers removing devices 3, turn freely whenever said feeler device 5, and particularly abutment portion 52, abuts against the trunk of a vegetable plant, in particular allowing suckers removing devices 3 to surround the trunk of the vegetable plant without applying any forces to the trunks through agricultural equipment 3, in particular said suckers removing devices 3. In particular, control system 25 is adapted to disable hydraulic system 38 in the event that said feeler device 5 detects contact with a trunk of a vegetable plant.

Preferably, agricultural machine 2 according to the present invention permits avoiding the use of any returning systems that might cause damage to the vegetable plants by exerting thrust forces on the trunk of the vegetable plant while agricultural equipment 3 is working around the trunk.

Agricultural machine 2 according to the present invention prevents trunks of vegetable plants from being subjected to forces generated by returning means, such as springs, for returning agricultural equipment 3 into the working configuration.

Any alternative embodiments which have not been expressly described herein, but which can be easily inferred by a person skilled in the art in the light of the technical contents of the present patent application, shall be considered to fall within the protection scope of the present patent application.

### REFERENCE NUMERALS

Agricultural machine 2
Support structure 22
Main arm 23
Distal end 231
Actuator system 24
Control system 25
Adjustment system 26
Agricultural equipment 3
Arm 32
Distal end 321
Cutting device 34
Protection structure 36
Protrusions 362
Adjuster device 363
Cavity 364
Abutment element 365
Hydraulic system 38
Safety system 4
Idle wheel 42
Connection portion 420
Movable portion 421
Return elements 422
Elastic member 424
Sensor 44
Feeler device 5
Abutment portion 52
First axis “Z1”
Second axis “Y2”
Third axis “Z3”
Fourth axis “X4”

1. An agricultural machine for working around trunks of vegetable plants, comprising:
a support structure, adapted to be connected to a vehicle or tractor;
a main arm, connected to said support structure, adapted to make a movement relative to said support structure;
an actuator system at least adapted to control the movements of said main arm to selectively move a distal end of the main arm towards or away from a trunk of a vegetable plant;
at least one agricultural equipment, adapted to work around trunks of vegetable plants, the at least one agricultural equipment being connected to said distal end of said main arm;
a control system, adapted to at least control said actuator system;
a safety system adapted to prevent said agricultural equipment from damaging the trunk of the vegetable plant around which said agricultural equipment is operating;
said safety system comprising: at least one idle wheel and at least one sensor;
said at least one sensor is adapted to detect the abutment of said at least one idle wheel against the trunk of a plant; said control system being adapted to control said actuator system so that said main arm will move in the event that said at least one sensor detects the abutment of said idle wheel against said trunk of the plant, thus moving the distal end of said main arm away from the trunk of the vegetable plant, se as to prevent said at least one idle wheel from exerting a force against said trunk.

2. The agricultural machine according to claim 1, wherein said control system is adapted to control said actuator system to prevent said idle wheel from abutting against said trunk.

3. The agricultural machine according to claim 1, wherein said idle wheel comprises return elements adapted to allow said idle wheel to change a position of an axis of symmetry or rotation in case of abutment against said trunk of the plant and to return into an idle position following an action exerted on said idle wheel by said trunk of the plant.

4. The agricultural machine according to claim 3, wherein said at least one sensor is adapted to determine the position of the axis of symmetry or rotation of said idle wheel relative to said idle position.

5. The agricultural machine according to claim 1, wherein at least one elastic member is on an outer perimeter of said idle wheel, said elastic member is adapted for damping, at least partly, an impact force of the idle wheel against the trunk of the vegetable plant.

6. The agricultural machine according to claim 1, said idle wheel being pivoted to the distal end of the main arm.

7. The agricultural machine according to claim 1, wherein said actuator system being a hydraulic system.

8. The agricultural machine according to claim 1, comprising an adjustment system, which is adapted for adjusting a spatial position of said agricultural equipment;
said control system being adapted to control said adjustment system.

9. The agricultural machine 2 according to claim 1, wherein said agricultural machine is a suckers removing machine adapted to remove suckers in proximity to the trunk of a vegetable plant.

10. The agricultural machine according to claim 9, wherein two suckers removing devices are present at the distal end of said main arm; each suckers removing device comprising:
an arm, hinged at one end to the distal end of said main arm and being rotatable about a first axis;
at least one cutting device, fixed to the distal end of the arm;
at least one protection structure, adapted to rotate idle about a third axis and facing said cutting device;
said two suckers removing devices being adapted to assume a working configuration and being driven by a hydraulic system.

11. The agricultural machine according to claim 10, wherein said safety system comprises a feeler device; said feeler device comprising an abutment portion; said feeler device being adapted to disable said hydraulic system of the suckers removing devices, allowing said arms to turn idle as long as a trunk of a vegetable plant is acting upon said abutment portion.

12. The agricultural machine according to claim 1, wherein said safety system comprises a feeler device;
said feeler device comprising an abutment portion adapted to disable a hydraulic system of at least one agricultural equipment, allowing said at least one agricultural equipment to turn idle about a first axis as long as a trunk of a vegetable plant is acting upon said abutment portion.
